(19) United States
(12) Patent Application Publication
(10) Pub. No.: US 2004/0166903 A1
(43) Pub. Date: Aug. 26, 2004

(54) Base station

(76) Inventor: Toshiaki Nakanishi, Yokohama-shi (JP)

Correspondence Address: SCHULTE ROTH & ZABEL LLP, ATTN: JOEL E. LUTZKER, 919 THIRD AVENUE, NEW YORK, NY, 10022, US

(21) Appl. No.: 10/781,210

(22) Filed: Feb. 17, 2004

(30) Foreign Application Priority Data
Feb. 17, 2003 (JP) 2003-038042

(51) Int. Cl. H04M 1/00; H04B 1/38

(52) U.S. Cl. 455/562.1; 455/63.4; 455/560

(57) ABSTRACT

A base station, which communicates with a radio terminal, has an adaptive antenna; and a control portion for controlling a directivity of said adaptive antenna, wherein said adaptive antenna includes a plurality of antenna elements, and phase shifters for changing phase of each signal to be transmitted from the plurality of antenna elements, and said control portion includes a receiving condition acquisition portion for acquiring a signal concerning a receiving condition of said radio terminal from said radio terminal, and a directivity control portion for controlling the directivity of said adaptive antenna to be varied based on the acquired signal concerning the receiving condition of said radio terminal. Therefore, the base station can recognize the receiving condition of the radio terminal based on the signal transmitted from the radio terminal so as to properly control directivity of the adaptive antenna.

### CROSS-REFERENCE TO RELATED APPLICATIONS

This application claims priority from Japanese Patent Application No. 2003-038042 filed on Feb. 17, 2003.

### BACKGROUND OF INVENTION

1. Field of the Invention

The present invention relates a base station having an adaptive antenna. Particularly, the present invention relates to a control system for the adaptive antenna of the base station in which CDMA (Code Division Multiple Access) system as a mobile communication system (cellular system) is preferably used.

2. Description of Related Art

In a mobile communication system such as a portable telephone system, a communications line by means of radio wave is established between a radio terminal and a base station, so that communications is carried out by transmitting/receiving voice signal, data, etc. by wireless.

A base station using an adaptive array antenna including a plurality of antenna elements is proposed in order to give directivity to the antenna. According to the related art concerning a control of an adaptive antenna of a base station, Eb/Io is calculated based on a result of a path search in CDMA to thereby form a directivity of the antenna in a direction where a mobile terminal exists.

JP-A-2000-23225 is known as a related art.

In most of mobile communication systems, a frequency of an upstream signal from a radio terminal to a base station and a frequency of a downstream signal from the base station to the radio terminal are different from each other. Therefore, in some cases, a transmission path for the upstream signal and a transmission path for the downstream signal may be different from each other. That is, a direction in which the base station receives a signal with a maximum receiving level, or a direction in which interference wave is at a minimum is not always an optimal direction for the case where the radio terminal receives radio wave transmitted from the base station. Accordingly, in the mobile communication systems except a mobile communication system using a TDD system in which a transmitting frequency and a receiving frequency are equal to each other, there may cause a circumstance that an optimal directivity for the base station cannot be attained even if the base station controls the directivity of its transmitting antenna based on a result of the received upstream signal.

### SUMMARY OF THE INVENTION

An object of the invention is to provide a base station, in CDMA system, which recognizes a receiving condition of a radio terminal on the basis of a DRC signal transmitted from the radio terminal, and properly controls a directivity of a transmitting antenna.

The invention provides a base station, which communicates with a radio terminal, having: an adaptive antenna; and

a control portion for controlling a directivity of said adaptive antenna, wherein said adaptive antenna includes a plurality of antenna elements, and phase shifters for changing phase of each signal to be transmitted from the plurality of antenna elements, and said control portion includes a receiving condition acquisition portion for acquiring a signal concerning a receiving condition of said radio terminal from said radio terminal, and a directivity control portion for controlling the directivity of said adaptive antenna to be varied based on the acquired signal concerning the receiving condition of said radio terminal.

Furthermore, said control portion sets the to be non-directional until a connection request is received from said radio terminal, and said directivity control portion controls the directivity of said adaptive antenna to be varied based on the acquired signal concerning the receiving condition of said radio terminal after receiving the connection request from said radio terminal.

### BRIEF DESCRIPTION OF DRAWINGS

FIG. 1 shows a block diagram showing the configuration of a base station according to an embodiment of the invention;

FIG. 2 shows a block diagram showing the configuration of the base station according to the embodiment of the invention;

FIG. 3 is a view for explaining the operation of an adaptive antenna of the base station according to the embodiment of the invention at the time of transmission; and

FIG. 4 is a view for explaining the operation of the adaptive antenna of the base station according to the embodiment of the invention at the time of reception.

### DETAILED DESCRIPTION OF THE PREFERRED EMBODIMENTS

An Embodiment of the present invention will be described with reference to the drawings.

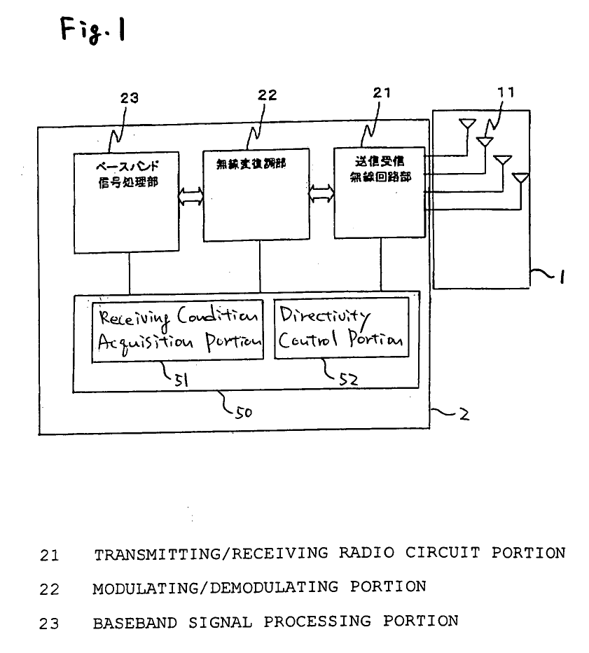

FIG. 1 shows a block diagram showing a main configuration of a base station according to an embodiment of the invention.

A base station 2 has an antenna array 1 configuring an adaptive antenna.

The antenna array (adaptive antenna) 1 has a plurality of antenna elements 11. The antenna array 1 is connected to the base station 2 by connecting the antenna elements 11 to a transmitting/receiving radio circuit portion 21.

The transmitting/receiving radio circuit portion 21 includes a transmitting portion and a receiving portion. The transmitting portion produces radio wave (high frequency signals) to be transmitted from the antenna array 1 to a radio terminal. The receiving portion amplifies or performing the frequency conversion for radio wave (high frequency signals) transmitted from the radio terminal and received by the antenna array 1, and outputs a resulting signal to a modulating/demodulating portion 22.

The modulating/demodulating portion 22 has an analog-digital converter (AD converter, DA converter) and a quadrature modulator. The modulating/demodulating portion 22 relays an analog signal used by the transmitting/receiving radio circuit portion 21 and a digital signal used by a baseband signal processing portion 23.

The baseband signal processing portion 23 has a DSP (Digital Signal Processor). By use of the DSP, the baseband signal processing portion 23 performs coding, decoding, compression and decompression of a coded signal, and error correction of a received signal.

The base station 2 further has a control portion 50. The control portion 50 is mainly configured by a CPU. The control portion 50 controls respective portions of the base station 2 based on data stored in a memory. The control portion 50 has a receiving condition acquisition portion 51 and a directivity control portion 52. The receiving condition acquisition portion 51 acquires a DRC signal concerning a receiving condition of a radio terminal from the radio terminal. The directivity control portion 52 controls the directivity of the antenna array 1 to be varied based on the acquired DRC signal.

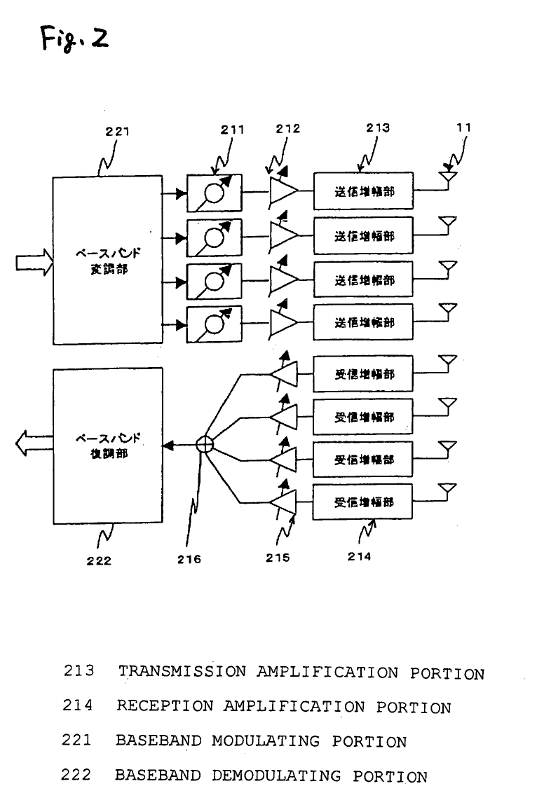

FIG. 2 shows a block diagram showing a detailed configuration of the transmitting/receiving radio circuit portion 21 and its periphery in the base station according to the embodiment of the invention.

An amplifier which enables to vary an amplification factor and a phase shifter which enables to vary the amount of phase shift are connected to each antenna element 11. The directivity of the antenna array 1 is changed in accordance with variation in characteristic of the amplifier and the phase shifter.

Specifically, high frequency signals which is output from a baseband modulating portion 221 are input to phase shifters 211 provided in parallel. Each phase shifter 211 is configured so that the control portion 50 controls the phase shifter 211 to vary the phase of a signal input to the phase shifter 211. The high frequency signals input to the phase shifters 211 are shifted to have different phases from one phase shifter to another. The high frequency signal whose phase is different from one phase shifter to another is input to a amplifier 212 corresponding to a phase shifter 211. Each amplifier 212 is configured so that the control portion 50 controls the amplifier 212 to vary the amplification factor. The high frequency signals input to the amplifiers 212 are amplified to have different amplitude factors from one amplifier to another. The high frequency signal output from the amplifier 212 is input to a transmission amplification portion 213 corresponding to a amplifier 212. The high frequency signal input to the transmission amplification portion 213 is then amplified to have power required for transmission to the radio terminal.

That is, the phase shifter 211, the amplifier 212 and the transmission amplification portion 213 are respectively provided for each of the antenna elements 11 and decide the phase and the power of the high frequency signal to be provided to each antenna element 11. The phase shifters 211 and the amplifiers 212 are controlled by the control portion 50. The control portion 50 controls the directivity of the antenna array 1 by controlling the phase and the power of the high frequency signal to be input to each antenna element 11.

Signals which are transmitted from the radio terminal and received by the antenna elements 11 are input to reception amplification portions 214 provided correspondingly to the antenna elements 11. The reception amplification portions 214 amplifies the signals to have strengths required for processing the signals in each portion of the base station 2. The amplified high frequency signals are input to amplifiers 215 provided correspondingly to the reception amplification portions 214. Each amplifier 215 is configured so that the control portion 50 controls the amplifier 215 to vary its amplification factor. The high frequency signals input to the amplifiers 215 are amplified to have different amplitude factors from one amplifier to another. The amplified high frequency signals are then synthesized by a mixer 216 and input to a baseband demodulation portion 222.

Incidentally, a pair of phase shifters 211 and a pair of amplifiers 212 may be provided so as to control beam steering and null steering of the transmitting antenna separately. In addition, a pair of amplifiers 215 may be provided so as to control beam steering and null steering of the receiving antenna separately.

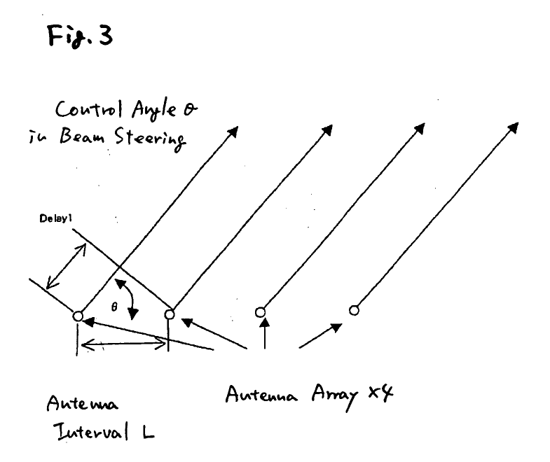

FIG. 3 is a view for explaining the operation of the adaptive antenna of the base station according to the embodiment of the invention. In FIG. 3, there is shown control of directivity of the adaptive antenna at the time of transmission.

In beam steering in which radio wave is intensively radiated in a certain direction, a delay of a high frequency signal supplied to each antenna element 11 (phase difference: Delay1) is represented by the following equation.

Delay1=N×λ=Lcos θ

where θ is an angle between a reference direction (direction of a row of the arrayed antenna elements) and a desired direction.

That is, when a phase difference of a transmission signal supplied to each antenna element 11 is controlled to satisfy the equation, radio wave is intensively transmitted in the direction of θ.

On the other hand, in null steering in which radio wave radiated in a certain direction is weakened, a delay of a high frequency signal supplied to each antenna element 11 (phase difference: Delay1) is represented by the following equation.

Delay1=(2×N+1)×λ/2=Lcos θ

where θ is an angle between a reference direction (direction of a row of the arrayed antenna elements) and a desired direction.

That is, when a phase difference of a transmitted signal supplied to each antenna element 11 is controlled to satisfy the equation, radio wave transmitted in the direction of θ can be weakened.

In these equations, N designates a number (integer) indicating the sequence of the antenna elements 11, λ designates a wavelength of the transmitting wave, and L designates an interval between adjacent ones of the antenna elements 11.

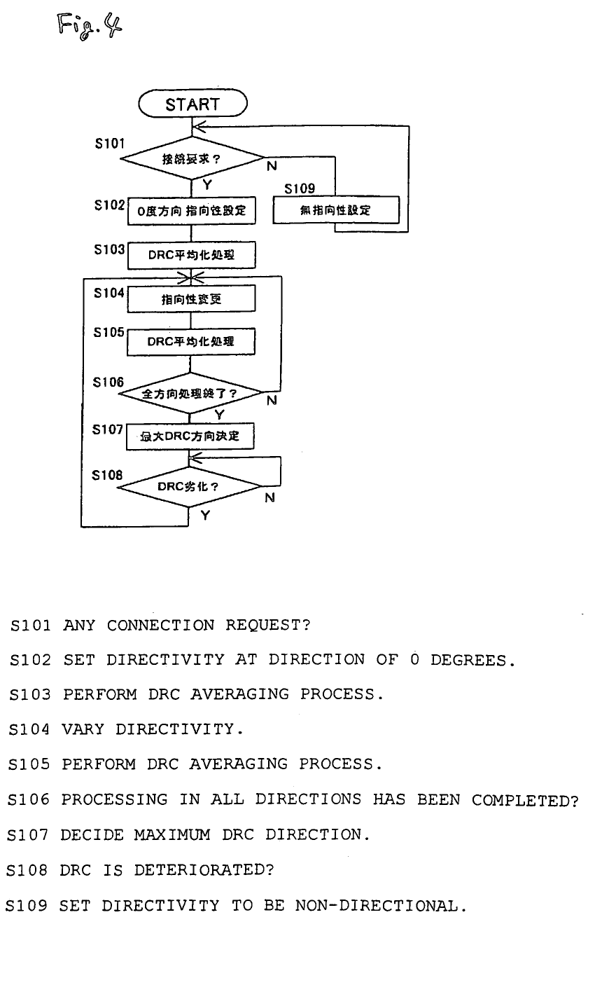

FIG. 4 is a flow chart showing control of the adaptive antenna of the base station according to the embodiment of the invention.

First, the control portion 50 judges as to whether or not the base station 2 receives a connection request from a radio terminal (S101). When no connection request from a radio terminal is detected, the control portion 50 sets characteristic of the transmitting antenna to be non-directional without controlling the directivity of the transmitting antenna, and transmits notice information (pilot signal) (S109). On the other hand, when a connection request from a radio terminal is detected, the control portion 50 sets the directivity of the transmitting antenna at a predetermined direction (e.g. a direction of 0 degrees), and transmits notice information (pilot signal) (S102).

The base station 2 then receives a DRC signal as a result that the radio terminal receives a signal from the base station 2. The DRC signal is used in a radio communication system using a CDMA 2000 1xEV-DO standard. The DRC signal indicates status information of the radio communication line which shows the condition of radio wave transmitted from the base station 2 and received by the radio terminal. The DRC signal is used for changing a rate of data transmitted from the base station 2 to the radio terminal by every slot. The DRC signal is transmitted from the radio terminal to the base station 2 at time intervals of 1.66 msec. Accordingly, the base station 2 performs a DRC averaging process for calculating an average of the DRC signal in a predetermined time (e.g. of 30 msec), so that the receiving condition of the signal transmitted from the base station 2 by the radio terminal is acquired while unexpected variation in the DRC signal is absorbed (S103).

After directivity is varied, the notice information (pilot signal) is transmitted with the varied directivity (S104). When, for example, directivity is changed by 20 degrees every 30 msec, search in all directions will be completed in 0.54 sec.

Next, the DRC averaging process for calculating an average of the DRC signal in a predetermined time (e.g. of 30 msec) is performed to acquire the receiving condition of the radio terminal (S105).

The control portion 50 judges as to whether or not transmission of notice information (pilot signal) and acquisition of the DRC information in all directions (360 degrees) are completed (S106). In the case where the acquisition of the DRC information in all directions is not completed yet, the current position of the routine goes back to S104 in which the directivity is further varied to acquire the DRC information.

On the other hand, in the case where the acquisition of the DRC information in all directions is completed, a direction which gives the best receiving condition based on the acquired DRC information is defined as the directivity of the transmitting antenna (S107).

The DRC information is monitored to make judgment as to whether or not the receiving condition of the radio terminal is deteriorated (S108). When deterioration of the receiving condition of the radio terminal is detected based on the DRC information, the current position of the routine goes back to S104 in which the directivity of the transmitting antenna is varied again to acquire the DRC information to thereby define a direction which gives the best receiving condition.

In the embodiment, although the direction which gives the best receiving condition is defined based on a result of comparison in the acquired DRC information, a threshold value may be provided for the DRC information so that a direction which gives good DRC information may be defined as the directivity of the transmitting antenna on the basis of a result of comparison with the threshold value. When the direction which gives good DRC information is defined based on the result of comparison with the predetermined threshold in this manner, it is unnecessary to decide optimal DRC information any more. Therefore, the directivity of the transmitting antenna can be rapidly defined.

Since the directivity of the antenna is controlled based on a signal (DRC signal) concerning a receiving condition from the radio terminal as described above, the directivity of the adaptive antenna can be controlled in accordance with a throughput.

Although the embodiment of the invention has been described above with reference to the drawings, the invention as to the specific configuration is not limited to the embodiment. Changes in design may be made without departing from the gist of the invention.

For example, DRC information in a predetermined direction may be acquired instead of acquisition of the DRC information in all directions.

According to the embodiment, the directivity of the adaptive antenna of a base station is controlled to be varied on the basis of a signal (DRC signal) concerning a receiving condition of a radio terminal. Therefore, in the radio communication system with different transmitting and receiving frequencies, the radio terminal can communicate in a good receiving condition. The present invention can apply to a mobile communication system using the TDD system too.

What is claimed is:

1. A base station, which communicates with a radio terminal, comprising:
an adaptive antenna;
a receiving condition acquisition portion for acquiring a signal concerning a receiving condition of said radio terminal from said radio terminal; and
a directivity control portion for controlling the directivity of said adaptive antenna based on the acquired signal concerning the receiving condition of said radio terminal.

2. The base station according to claim 1,
wherein said directivity control portion sets the to be non-directional until a connection request is received from said radio terminal, and controls the directivity of said adaptive antenna based on the acquired signal concerning the receiving condition of said radio terminal after receiving the connection request from said radio terminal.
